(19) United States
(12) Patent Application Publication
(10) Pub. No.: US 2009/0272488 A1
(43) Pub. Date: Nov. 5, 2009

(54) VEHICLE COATING METHOD AND COATING LINE

(75) Inventor: Motoi Ogasawara, Tokyo (JP)

Correspondence Address: STANDLEY LAW GROUP LLP, 6300 Riverside Drive, Dublin, OH, 43017, US

(73) Assignee: HONDA MOTOR CO., LTD., Tokyo (JP)

(21) Appl. No.: 12/094,914

(22) PCT Filed: Nov. 17, 2006
(86) PCT No.: PCT/JP2006/323032

§ 371 Date: May 23, 2008

(30) Foreign Application Priority Data
Nov. 24, 2005 (JP) 2005-338075

(51) Int. Cl. B32B 37/02; B05D 3/02; B05C 11/00

(52) U.S. Cl. 156/280; 427/375; 156/390; 118/68

(57) ABSTRACT

A coating line for a vehicle, which includes a station where an intercoating step is conducted, stations where a topcoating step is conducted, and a station that is disposed downstream from these stations and in which a baking/drying step is conducted. It further includes the following stations disposed in the following order downstream from these stations: a coating station where a coating step for applying a protective-layer-forming material to the surface of the coating is conducted; a sealing station where sheet joints are sealed with a sealing material; a sheet attachment station in which a bituminous sheet is attached to the vehicle in a given position; and a heating station where a heating step for fusion-bonding the bituminous sheet and drying the sealing material and protective-layer-forming material is conducted.

### TECHNICAL FIELD

The present invention relates to a vehicle coating method and a coating line, and more particularly to a vehicle coating method and a coating line which have a process and a station for mounting a polymeric material such as a sheet material which is fusible with heat, a sealing material which solidifies when dried, or the like, in a predetermined position on a vehicle.

### BACKGROUND ART

In a coating process carried out while a vehicle is being manufactured, the vehicle is coated and thereafter the coating is baked and dried to a hardened state. Vehicles have various polymeric materials incorporated therein. The polymeric materials include a bituminous sheet (or rubber sheet) applied to the floor and dashboard for isolating vibrations and insulating sounds, and a sealing material applied to seal steel panel seams, etc. The bituminous sheet is secured to the vehicle body when fused with heat, and the sealing material is secured to the vehicle body when dried and solidified.

Patent document 1 discloses an example in which a bituminous sheet is mounted in a predetermined position on a vehicle, and thereafter baked and dried, so that the coating is hardened and the bituminous sheet is fused at the same time.

The coating which is hardened by being baked is chemically stable and is essentially free of deterioration. However, while the coated vehicle is being kept in storage over a long period of time and being transported after the vehicle has been manufactured, the quality of a surface layer among a plurality of coating layers on the vehicle may possibly be lowered. In attempts to prevent such a problem, the present applicant has proposed, in Patent document 2, a coating system suitable for coating a coating region of a vehicle with a protective layer forming material (called strippable paint) which will form a peelable protective layer.

The protective layer forming material comprises a liquid lapping material. After the protective layer forming material is applied to the coating region of the vehicle, it is dried into a peelable protective layer which chemically and physically protects the coating region from dirt particles, metal particles, salt, oil, acids, direct sunlight, etc. The peelable protective layer can easily be removed by being peeled off from the coating region. The peelable protective layer does not peel off on its own while in normal storage.

According to the process disclosed in Patent document 1, since the overcoat is not dried when the polymeric material is mounted on the predetermined position on the vehicle, dirt, dust, powder, etc. that are produced upon the mounting of the polymeric material may possibly be applied to the undried overcoat. Specifically, part of the polymeric material may be scattered as dirt or the like and attached to the overcoat, and part of the wear and hair of the worker who mounts the polymeric material may be attached to the overcoat. Since such dirt or the like remains securely trapped in the overcoat in the baking and drying process, it is necessary to find the trapped dirt in a subsequent strict inspection process and appropriately repair the overcoat. Specifically, the overcoat needs to be scraped off not only from the area around the dirt but also from a wide area to prevent color irregularities, and to be recoated and baked again. Accordingly, a large burden is imposed on the worker.

The above difficulties are not caused if the process of mounting the polymeric material is carried out after the backing and drying process. However, since a dedicated heating process is needed for fusing the polymeric material, an extra working time, an extra space for carrying out the heating process, and an extra amount of energy required for heating are required, resulting in an inefficient operation.

When the protective layer forming material is dried naturally, it is turned into a good-quality protective film. However, the natural drying takes a long time, making the manufacture of the vehicle inefficient. Specifically, until the protective layer forming material is dried, a certain storage space is required to prevent the vehicle from being touched carelessly, and the time required to manufacture the vehicle is substantially increased.

Patent document 1: Japanese Patent Publication No. 62-16709
Patent document 2: Japanese Laid-Open Patent Publication No. 2004-216365

### DISCLOSURE OF THE INVENTION

It is an object of the present invention to provide a vehicle coating method and a coating line which are effective to prevent dirt or the like produced when a polymeric material such as a sheet material, a sealing material, or the like is mounted and applied, from being trapped in a coating, and which are capable of drying a protective layer forming material in a short period of time.

According to the present invention, there is provided a method of coating a vehicle while the vehicle is being manufactured, comprising a baking and drying step of baking and drying an overcoat applied to the vehicle; a sheet mounting step of mounting a sound-insulating sheet or a vibration-isolating sheet which is fusible with heat, in a predetermined position on the vehicle, after the baking and drying step; a coating step of applying a protective layer forming material on the baked and dried overcoat; and a heating step of heating and fusing the sound-insulating sheet or the vibration-isolating sheet which is mounted on, and heating and drying the protective layer forming material.

According to the present invention, there is also provided a method of coating a vehicle while the vehicle is being manufactured, comprising a baking and drying step of baking and drying an overcoat applied to the vehicle; a sealing step of closing a panel seam with a sealing material which can be dried and hardened, after the baking and drying step; a coating step of applying a protective layer forming material on the baked and dried overcoat; and a heating step of heating and drying the sealing material and the protective layer forming material.

The sheet mounting step and the sealing step are carried out after the overcoat is baked and dried. Consequently, even if dirt produced by the mounting of the sheet and also by the sealing step is applied to the coating surface, since the coating surface has been hardened by the baking and drying step at this time, the dirt is not trapped in the coating. The dirt can simply be wiped off, so that the coating does not need to be scraped off and the coating surface does not need to be coated again.

Since the heating step is carried out after the sheet is mounted, the sealing process is performed, and the protective layer forming material is applied, the sheet and the sealing material are dried, and the protective layer forming material is dried, at the same time.

According to the present invention, there is provided a coating line for coating a vehicle while the vehicle is being manufactured, comprising a baking and drying station for baking an overcoat applied to the vehicle, a sheet mounting station for mounting a sound-insulating sheet or a vibration-isolating sheet which is fusible with heat, in a predetermined position on the vehicle, downstream of the baking and drying station, a coating station for applying a protective layer forming material on the baked and dried overcoat, and a heating station for heating and fusing the sound-insulating sheet or the vibration-isolating sheet which is mounted on, and heating and drying the protective layer forming material.

According to the present invention, there is also provided a coating line for coating a vehicle while the vehicle is being manufactured, comprising a baking and drying station for baking an overcoat applied to the vehicle, a sealing station for closing a panel seam with a sealing material which can be dried and solidified, downstream of the baking and drying station, a coating station for applying a protective layer forming material on the baked and dried overcoat, and a heating station for heating and drying the applied sealing material and protective layer forming material.

The sheet mounting station and the sealing station are used after the overcoat is baked and dried. Consequently, even if dirt produced by the mounting of the sheet and also by the sealing is applied to the coating surface, since the coating surface has been hardened by baking and drying at this time, the dirt is not trapped in the coating. Since the heating is operated after the sheet is mounted, the sealing material is applied, and the protective layer forming material is applied, the sheet is fused and the sealing material is dried, and the protective layer forming material is dried, at the same time.

With the coating method and the coating line according to the present invention, the steps of and the stations for mounting the sheet and sealing are performed and positioned after the overcoat is baked and dried. Consequently, even if dirt produced by the mounting of the sheet and also by sealing is attached to the coating surface, since the coating surface has been hardened by the baking and drying of the overcoat at this time, the dirt is not trapped in the coating, but can simply be wiped off, so that the coating does not need to be scraped off and the coating surface does not need to be coated again. Heating is carried out after the steps and the stations for mounting the sheet and sealing and after the protective layer forming material is applied. Therefore, the sheet is fused and the sealing material is dried, and the protective layer forming material is dried, at the same time. It is not necessary to provide a heating step and a heating station dedicated for each process. The working time, the space required for the heating step, and the energy required for the heating are thus commonly used efficiently.

As the protective layer forming material is dried with heat in a short period of time, it is free of such disadvantages that a space is provided to keep the vehicle in storage until the protective layer forming material is dried and the substantial time required to manufacture the vehicle is increased.

### BRIEF DESCRIPTION OF THE DRAWINGS

FIG. 1 is a schematic diagram of a coating line according to an embodiment of the present invention;

FIG. 2 is a perspective view of a station for applying a protective layer forming material;

FIG. 3 is a view showing the manner in which a steel panel seam is filled with a sealing material;

FIG. 4 is a view showing the manner in which the worker applies bituminous sheets to a vehicle; and

FIG. 5 is a perspective view of a station for heating vehicles.

### BEST MODE FOR CARRYING OUT THE INVENTION

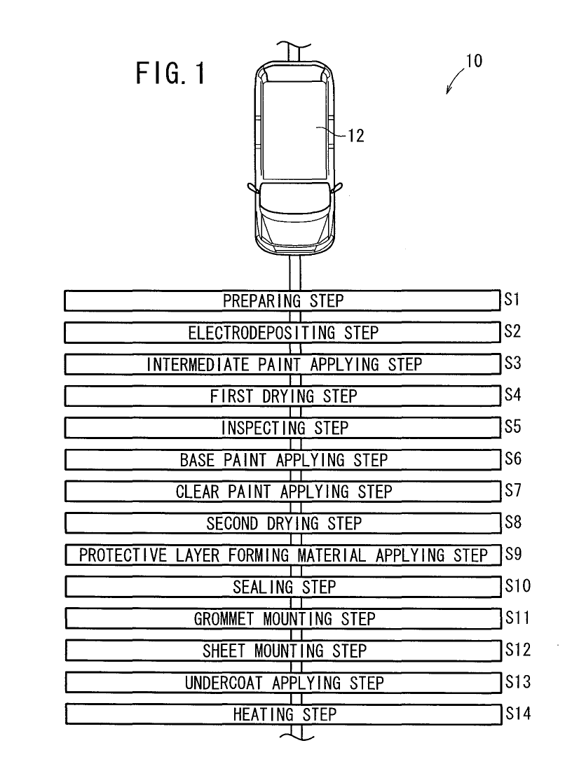

A vehicle coating method and a coating line according to an embodiment of the present invention will be described below with reference to FIGS. 1 through 5 of the accompanying drawings.

As shown in FIG. 1, a coating line 10 according to the present embodiment, which is installed in a factory for manufacturing vehicles 12, coats the vehicles 12 while the vehicles 12 are being successively fed along, and applies a protective layer forming material to each of the vehicles 12 for protecting the applied coating. The coating line 10 has coating stations S1 through S14. The vehicle coating method according to the present embodiment is a method having steps corresponding to the respective stations of the coating line 10. The method and the coating line 10 will be described together below.

The station S1 is a station for performing a preparing step including a degreasing step and a chemical conversion step on the vehicle 12 which has been welded. In the chemical conversion step, a chemically stable inorganic film is formed on the steel panel surface of the vehicle 12 to inactivate and make the steel panel surface resistant to rust, and also to increase the adhesion between the steel panel surface and a coating.

The station S2 is a station for performing an electrodepositing step to electrodeposit a highly rust-resistant cationic electrodeposition paint (e.g., a paint made mainly of epoxy resin) on the steel panel surface.

The station S3 is a station for performing an intermediate paint applying step to apply a given intermediate paint to the steel panel surface to which the electrodeposition paint has been applied.

The station S4 is a station for performing a first drying step. The station S4 includes a drying furnace suitable for drying and hardening the intermediate paint by heating the intermediate paint at a predetermined temperature for a predetermined time.

The station S5 is a station for performing an inspecting step to inspect the coated surface to which the intermediate paint has been applied, and to clean and repair the coating surface if scratch, dirt, etc. are present on the coating surface. The inspecting step can be performed easily and simply because there is a very small possibility for dirt or the like to be applied to the coating surface up to this point.

The station S6 is a station for performing a base paint applying step to apply a base paint of an overcoat.

The station S7 is a station for performing a clear paint applying step to apply a clear paint of the overcoat.

The station S8 is a station for performing a second drying step. The station S8 includes a baking and drying furnace suitable for drying and hardening the overcoat by heating the overcoat at a predetermined temperature for a predetermined time.

In the stations S1 through S8, since the coating formed on the vehicle 12 is stably solidified, any dirt or the like which may subsequently be applied to the coating will not be trapped in the coating.

The station S9 is a station for applying a protective layer forming material on the coating surface (e.g., an engine cover, a roof, etc.) coated with the overcoat that is baked and dried.

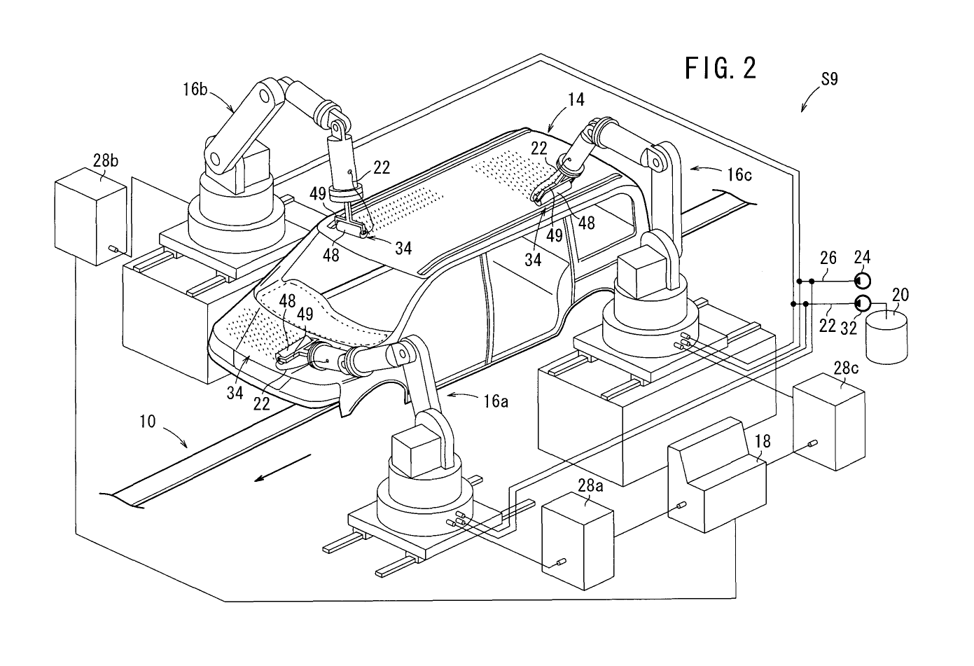

Specifically, as shown in FIG. 2, the station S9 comprises three robots 16a, 16b, 16c each in the form of an industrial 6-axis articulated robot, a controller 18 for controlling the entire system of the station, a tank 20 containing the protective film forming material, a coating material piping 22 connecting the tank 20 to the robots 16a through 16c, and a water piping 26 for supplying water from a water supply source 24 to the robots 16a through 16c. The robots 16a through 16c are controlled by respective robot controllers 28a, 28b, 28c connected to the controller 18.

A pump 32 is connected to the coating material piping 22 for drawing the protective film forming material from the tank 20 and supplying the protective film forming material to the robots 16a through 16c. The protective film forming material is controlled at an appropriate temperature by a heater and a thermometer, not shown. The robots 16a through 16c have respective roller mechanisms 34 as their end effectors which are supplied with the protective film forming material through the coating material piping 22.

The protective film forming material includes an acrylic copolymer as a main component, and should preferably have two types of acrylic copolymers having different glass transition temperatures. The protective film forming material can have its viscosity adjusted by the ratio at which it is mixed with water and a change in the temperature thereof. When the protective film forming material is dried, it closely adheres to the vehicle 12 and can chemically and physically protect the coating region of the vehicle 12 from dirt particles, metal particles, salt, oil, acids, direct sunlight, etc.

When the robots 16a through 16c operate, the roller mechanisms 34 connected as the end effectors can be moved to arbitrary positions near the vehicle 12 and can also be set to arbitrary orientations.

Each of the roller mechanisms 34 has a roller 48 on its distal end which is of a hollow cylindrical shape and made of a material capable of absorbing and holding the protective film forming material. The roller 48 is rotatably mounted on a holder 49 which has an end connected to the coating material piping 22. The roller 48 has an axially central portion supplied with the protective film forming material from the coating material piping 22. The supplied protective film forming material seeps out onto the surface of the roller 48 and is applied to the vehicle 12. The roller 48 may be made of sponge, bristles, or the like. The roller 48 can be detached from the holder 49 for replacement, cleaning, and maintenance.

The station S9 is not limited to carrying out the coating method using the rollers 48, but may spray the protective film forming material using coating nozzles, for example. The protective film forming material may be applied not only in the single station S9, but also in a plurality of stations sorted for coarse coating and finish coating. The means for applying the protective film forming material are not limited to the robots 16a through 16c, but may be a portal apparatus covering left, right, and upper sides of the vehicle 12 and the coating line 10, for example, and having the roller mechanisms 34 or coating nozzles for applying or spraying the protective film forming material. The protective film forming material may alternatively be applied manually by roller brushes or the like.

The step of applying the protective film forming material (the step of the station S9) is carried out immediately after the baking and drying step (the step of the station S8) that is carried out after the overcoat is applied. Therefore, the time during which the hardened stable coating is exposed is reduced for thereby protecting the coating more reliably. The drying of the protective film forming material is accelerated by residual heat from the heating of the vehicle 12.

The stations S10 through S13 perform the steps of mounting or applying polymeric materials to given positions on the vehicle 12. The polymeric materials include various auxiliary materials to be incorporated in the vehicle 12, other than paints.

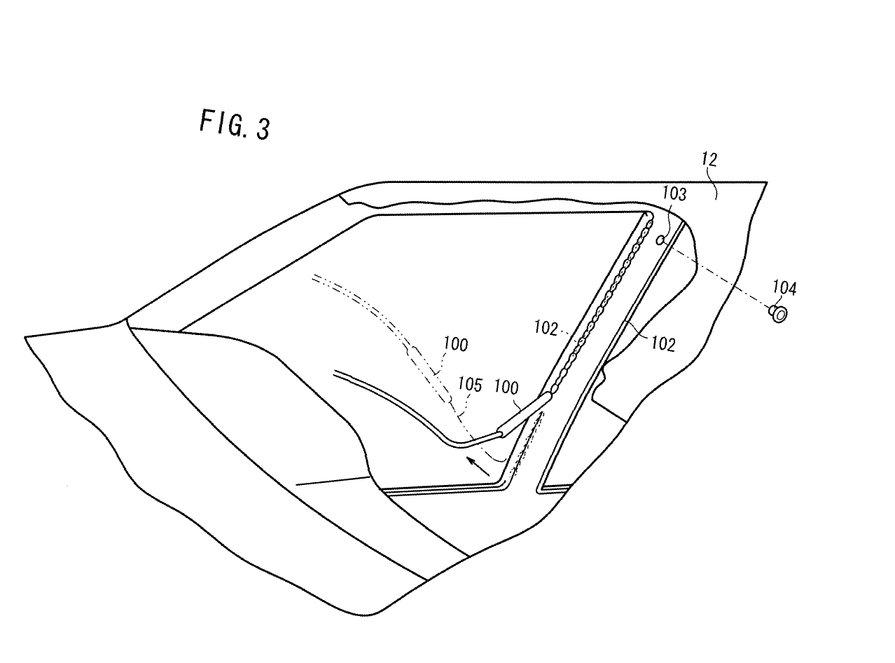

The station S10 is a station for performing a sealing step. As shown in FIG. 3, in order to prevent water and ambient air from entering the vehicle 12, a sealing material is expelled from a coating nozzle 100 to fill a steel panel seam 102 or a hemmed edge or the like, thereby closing the steel panel seam 102. The sealing material comprises a semiliquid polymeric material which is solidified when dried, such as an acrylic vinyl sol, a bituminous material, or the like, for example. Though the sealing material is usually colored, it may be transparent if used in regions where the colored sealing material would cause appearance problems.

After the sealing material stops being expelled from the coating nozzle 100 by operating a valve, part 105 of the sealing material may be elongated due to its viscosity, as indicated by the imaginary lines in FIG. 3, and may be attached to the coating region as dirt.

The station S11 performs a grommet mounting step to mount a grommet 104 of rubber in a hole 103 (see FIG. 3).

The station S12 is a station for performing a sheet mounting step to mount bituminous sheets (or rubber sheets) which are capable of isolating vibrations and insulating sounds, on predetermined positions on the vehicle 12. The bituminous sheets are made of a polymeric material which is fusible with heat, such as an asphalt material or the like, for example. The bituminous sheet is also called a fusible insulator.

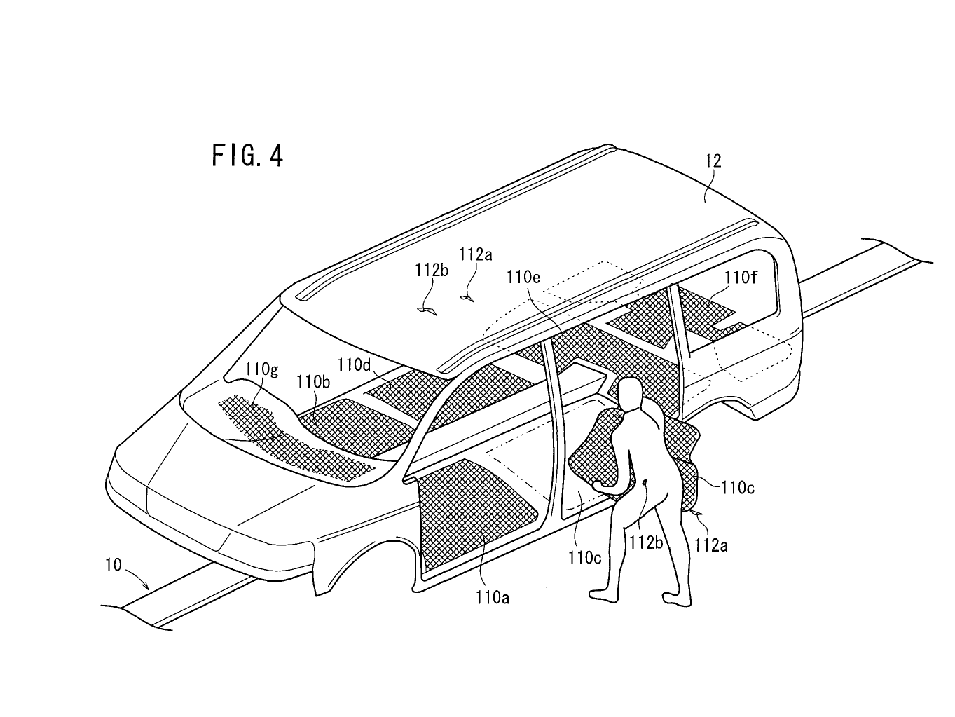

As shown in FIG. 4, the bituminous sheets include sheets 110a, 110b placed in left and right areas in front of front seats on the floor of the vehicle 12, sheets 110c, 110d placed in left and right areas behind the front seats, a sheet 110e placed at rear seats, a sheet 110f on a rear room floor, and a sheet 110g placed on a dashboard. These sheets 110a through 100g are mounted on the floor and dashboard by the worker in the station S12.

When the worker mounts the sheets 110a through 100g in place, part 112a of the bituminous sheets may be scattered as dirt or the like and attached to the coating, and part 112b of the wear of the worker, or part of hair of the worker may be attached to the coating.

The station S13 is a station for performing an undercoat applying step to apply or spray a predetermined under body coat to the floor reverse surface and steel panel seams in wheel houses for better water resistance, dirt prevention, rust prevention, and pitching resistance (to prevent damage by jumping pebbles). The under body coat may be of the same material as the sealing material. Part of the under body coat may also be scattered and applied to the coating region.

Even if the dirt produced in the stations S10 through S13 (part of the sealing material, part of the under body coat, part of the bituminous sheets, the wear and hair of the worker, etc.) is attached to the coating region, since the overcoat has already been hardened in the baking and drying step (the step in the station S8) and is covered with the protective layer forming material, the dirt will not be trapped in the coating. Though the protective layer forming material is not sufficiently dried at this time, it can nevertheless prevent the dirt from contacting the overcoat. Even if the dirt is attached to the coating region, it can simply be wiped off. Since it is not necessary to scrape off the coating over a wide area and to re-coat and re-bake the coating region, the coating method is efficient and reduces the burden on the worker.

The steps of mounting the polymeric material in the vehicle 12 (the steps in the stations S10 through S13) may be performed between the baking and drying step (the step in the station S8) subsequent to the overcoating step, and the step of applying the protective layer forming material (the step in the station S9), depending on various conditions. In view of the wiping-off process, the step of applying the protective layer forming material should preferably be performed earlier.

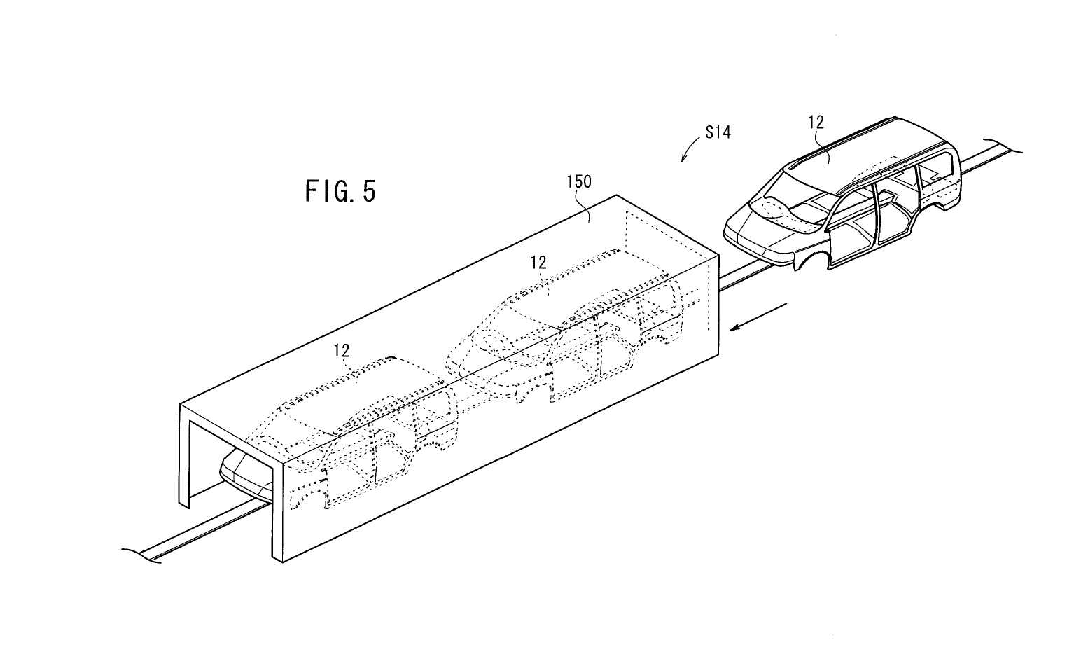

The station S14 is a station for performing a heating step to fuse and dry the mounted and applied polymeric material and to dry the protective layer forming material. As shown in FIG. 5, a heating furnace 150 heats the vehicle 12 at a predetermined temperature for a predetermined time. When the vehicle 12 is thus heated, the sealing material that has filled in the station S10 is dried and hardened, closing the steel panel seam 102. The bituminous sheets mounted in the station S12 are fused and hardened, and hence secured to the vehicle 12 for insulating sounds and isolating vibrations. Furthermore, the under body coat that has been applied or sprayed is dried and hardened for water resistance and dirt prevention. In the station S14, the applied protective layer forming material is dried more quickly than if it is dried naturally, and protects the coating. The peelable protective layer which is formed of the protective layer forming material is capable of protecting the coating region after the vehicle 12 is shipped out of the factory. In the factory, the peelable protective layer is also capable of protecting the coating region in subsequent adjusting and inspecting steps, and hence is used as a substitute for a scratch cover.

The peelable protective layer can easily be removed by being peeled off from the coating region. The peelable protective layer does not peel off on its own while in normal storage. When the peelable protective layer is removed, the dirt produced and attached in the stations S10 through S13 is also removed together with the peelable protective layer.

With the vehicle coating method and the coating line 10 according to the present embodiment, the respective steps of the stations S10 through S13 are performed after the baking and drying step (the step in the station S8). Consequently, even if dirt produced by the mounting of the sheets and also by sealing is attached to the coating surface, since the coating surface has been hardened by baking and drying at this time, the dirt is not trapped in the coating, but can simply be wiped off, so that the coating does not need to be scraped off and the coating surface does not need to be coated again.

As the heating step (the step in the station S14) is carried out after the sheets are mounted, the sealing process is performed, and the protective layer forming material is applied, the polymeric material is fused and dried, and the protective layer forming material is dried, at the same time. Therefore, it is not necessary to provide a heating step and a heating station dedicated for respective processes. The working time, the space required for the heating step, and the energy required for the heating are thus commonly used efficiently.

Some polymeric materials may be applied in a zone (e.g., between the station S2 and the station S3) upstream of the baking and drying step (the step in the station S8). For example, the step of mounting the grommet 104 (the step in the station S11), the step of mounting the sheet 110g on the dashboard, or the step of sealing the floor surface of the vehicle body may be performed prior to the baking and drying step since almost no dirt is produced in these steps. In other words, of the sheet mounting and sealing steps, at least those steps which are highly likely to produce dirt may be carried out after the baking and drying step.

With the vehicle coating method and the coating line 10 according to the present embodiment, it is not necessary to provide a heating step and a heating station dedicated for respective processes. The working time, the space required for the heating step, and the energy required for the heating are thus commonly used efficiently.

As the protective layer forming material is dried with heat in a short period of time, it is free of such disadvantages that a space is provided to keep the vehicle in storage until the protective layer forming material is dried and the substantial time required to manufacture the vehicle is increased.

The vehicle coating method and the coating line according to the present invention are not limited to the above embodiment, but may be modified to incorporate various arrangements and steps without departing from the scope of the invention.

1: A method of coating a vehicle while the vehicle is being manufactured, comprising:
a baking and drying step of baking and drying an overcoat applied to the vehicle;
a sheet mounting step of mounting a sound-insulating sheet or a vibration-isolating sheet which is fusible with heat, in a predetermined position on the vehicle, after said baking and drying step;
a coating step of applying a protective layer forming material on the baked and dried overcoat; and
a heating step of heating and fusing the sound-insulating sheet or the vibration-isolating sheet which is mounted on, and heating and drying said protective layer forming material.

2: A method of coating a vehicle according to claim 1, further comprising:
a sealing step of closing a panel seam with a sealing material which can be dried and solidified, after said baking and drying step and before said coating step.

3: A method of coating a vehicle according to claim 1, wherein said sound-insulating sheet or said vibration-isolating sheet comprises a bituminous sheet.

4: A method of coating a vehicle while the vehicle is being manufactured, comprising:
a baking and drying step of baking and drying an overcoat applied to the vehicle;
a sealing step of closing a panel seam with a sealing material which can be dried and solidified, after said baking and drying step;
a coating step of applying a protective layer forming material on the baked and dried overcoat; and
a heating step of heating and drying the applied sealing material and the applied protective layer forming material.

5: A method of coating a vehicle according to claim 4, wherein said sealing material comprises a bituminous material or an acrylic vinyl sol.

6: A coating line for conveying a vehicle while the vehicle is being coated in manufacturing of the vehicle, comprising:
a baking and drying station for baking an overcoat applied to the vehicle;
a sheet mounting station for mounting a sound-insulating sheet or a vibration-isolating sheet which is fusible with heat, in a predetermined position on the vehicle, downstream of said baking and drying station;
a coating station for applying a protective layer forming material on the baked and dried overcoat; and
a heating station for heating and fusing the sound-insulating sheet or the vibration-isolating sheet which is mounted on, and heating and drying said protective layer forming material.

7: A coating line according to claim 6, further comprising:
a sealing station for closing a panel seam with a sealing material which can be dried and solidified, after said baking and drying station and before said coating station.

8: A coating line according to claim 6, wherein said sound-insulating sheet or said vibration-isolating sheet comprises a bituminous sheet.

9: A coating line for conveying a vehicle while the vehicle is being coated in manufacturing of the vehicle, comprising:
a baking and drying station for baking an overcoat applied to the vehicle;
a sealing station for closing a panel seam with a sealing material which can be dried and solidified, downstream of said baking and drying station;
a coating station for applying a protective layer forming material on the baked and dried overcoat; and
a heating station for heating and drying the applied sealing material and the applied protective layer forming material.

10: A coating line according to claim 9, wherein said sealing material comprises a bituminous material or an acrylic vinyl sol.
